(19) United States
(12) Patent Application Publication
(10) Pub. No.: US 2017/0153127 A1
(43) Pub. Date: Jun. 1, 2017

(54) METHOD FOR DETERMINING AN ORTHOGONALITY ERROR BETWEEN TWO SENSOR SIGNALS

(71) Applicant: CONTINENTAL AUTOMOTIVE GMBH, Hannover (DE)

(72) Inventors: Jens Gleissberg, Schwalbach a.Ts. (DE); Markus Irth, Mainz-Kastel (DE)

(73) Assignee: CONTINENTAL AUTOMOTIVE GMBH, Hannover (DE)

(21) Appl. No.: 15/432,580

(22) Filed: Feb. 14, 2017

Related U.S. Application Data
(63) Continuation of application No. PCT/EP2015/068711, filed on Aug. 13, 2015.

(30) Foreign Application Priority Data
Aug. 13, 2014 (DE) 10 2014 216 224.6
Oct. 7, 2014 (DE) 10 2014 220 331.7

(51) Int. Cl. G01D 5/244

(52) U.S. Cl. CPC G01D 5/24476

(57) ABSTRACT

The disclosure relates to a method for determining a corrected rotation angle of a raw rotation angle recorded using an angle sensor which, on the basis of the raw rotation angle, outputs first and second raw rotation angle signals which have a periodic profile and are in an orthogonal relationship with one another. A deviation from the orthogonal relationship between the sensor signals can occur based on the error. The method includes: determining a correction value by means of a determination unit for determining the correction value and making the correction value available to a correction unit, applying the correction value to at least one of the raw rotation angle signals by means of the correction unit for determining at least one corrected rotation angle signal, and calculating the corrected rotation angle using at least one of the corrected rotation angle signals.

### CROSS-REFERENCE TO RELATED APPLICATIONS

This application claims the benefit of PCT Application PCT/EP2015/068711, filed Aug. 13, 2015, which claims priority to German Application DE 10 2014 216 224.6, filed Aug. 14, 2014 and German Application DE 10 2014 220 331.7, filed Oct. 7, 2014. The disclosures of the above applications are incorporated herein by reference.

### TECHNICAL FIELD

The disclosure relates to a method for determining a corrected rotational angle of a raw rotational angle captured by means of an angle sensor, an angle sensor arrangement and a drive device for carrying out such a method.

### BACKGROUND

The prior art has disclosed the document DE 10 2010 003 201 A1, which discloses a method for determining a rotational angle using an angle measuring unit. This document discloses how the rotational angle may be corrected by means of a correction value such that the influence of a phase displacement F on the value of the rotational angle is reduced. This relates to an error resulting from orthogonality between a sine-shaped sensor signal and a cosine-shaped sensor signal of the sensor element not being quite exact.

Further, the application DE 10 2014 216 224.6, which establishes the priority, discloses a method which highlights a different option to the one in the aforementioned document for determining the orthogonality error or a correction value for correcting the orthogonality error between the two angle signals.

### SUMMARY

The disclosure highlights an option which allows a corrected rotational angle calculation or determination to be carried out precisely and in a simple manner.

One aspect of the disclosure provides a method, by means of which determining the correction value and introducing the correction value into the rotational angle calculation may be integrated into existing processes as easily as possible. Based on the method, in particular the determining unit, it is possible to implement the error correction in an already established operation in a particularly flexible manner. Moreover, it is possible to adapt the options for calculating or determining the correction value according to requirements, for example depending on requirements relating to the accuracy of the calculation of the correction value. In contrast to the prior art, a determining unit for determining the correction value is used in addition to a correction unit. In this way, it is possible to flexibly set the manner in which the correction value is established in the determining unit.

The method is developed such that rotational angle signals corrected by means of the correction value are ascertained for both raw rotational angle signals and the corrected rotational angle are calculated by means of both corrected rotational angle signals. This ensures that both raw rotational angle signals are corrected in such a way that they substantially assume their setpoint values.

The method may be developed such that the corrected rotational angle signals are normalized to form normalized rotational angle signals, for example, to a value range between −1 and 1. By means of the normalization, the corrected rotational angle signals are prepared in such a way that determining the corrected rotational angle may be carried out independently of the scaling of the raw rotational angle signals. The method according to the disclosure may therefore be applied to a multiplicity of sensor types.

Thus, according to the disclosure, a method for determining a corrected rotational angle (x_tl) of a raw rotational angle (x), or angle sensor signal, captured by means of an angle sensor is proposed. The angle sensor outputs first and second raw rotational angle signals (s_r, c_r), or sensor signals, depending on the raw rotational angle (x). The said raw rotational angle signals or sensor signals have a periodic profile and are orthogonal to one another. A deviation from the orthogonal relationship between the sensor signals may occur on account of the error (y). The method includes the following steps: determining a correction value (y) by means of a determining unit for determining the correction value (y) and providing the correction value (y) to a correction unit, applying the correction value to at least one of the raw rotational angle signals (s_r, c_r) by means of the correction unit for determining at least one corrected rotational angle signal (s_oc, c_oc), and calculating the corrected rotational angle (x_tl) on the basis of at least one of the corrected rotational angle signals (s_oc, c_oc).

Implementations of the disclosure may include one or more of the following optional features. The method according to the disclosure is advantageously developed such that the corrected raw rotational angle signals, preferably the normalized raw rotational angle signals, are retrieved continuously for determining the correction value. The so-called online determination of the correction value allows an even more precise determination of the correction value. In this way, the external influences on the raw rotational angle signals, and also other influences which lead to a change in the orthogonality error, may be taken into account continuously. This also allows an oscillation behavior of the orthogonality error to be taken into account continuously in the correction value as well. Particularly in the case of applications in the automotive branch, for example in the case of driver assistance, this example may be particularly advantageous for determining an exact driver assistance torque.

In some implementations, determining the correction value includes the following steps: forming a radius signal by means of the sum of squares of the corrected or normalized raw rotational angle signals, determining the 2*n-th harmonic of the radius signal, where n equals a positive integer, and determining the error on the basis of a value of the amplitude, phase shifted by 90° in relation to the rotational angle, at the second harmonic.

This way of determining the error correction may be implemented in a particularly simple manner and was found to be a particularly stable and accurate method for determining the error correction. It may be carried out both online and offline. The advantage of this implementation lies in the fact that the error is established based on the radius signal, which may be determined merely on the basis of the two raw rotational angle signals. Since these signals are needed in any case for determining the rotational angle, there is no need to change the existing rotational angle sensors. There is no need for a reference sensor signal, to which the sensor signals could be compared individually, in order to ascertain the error in the individual sensor signals. The method may therefore be integrated particularly easily into existing systems since the electronic means required for evaluating the sensor signals are present in any case.

The mathematical derivation emerges as follows below. The amplitude of the radius signal may be mapped by means of the equation:

e_orth(x)=sin²(x)+cos²(x+y), (1)

where x represents the value of the rotational angle and y represents the value of the error. To the extent that the error y=0, the aforementioned condition of the addition theorem is satisfied.

Inter alia, the amplitude of the radius signal has a maximum at an angle of 45°, and so the radius signal assumes the following value at x=45°:

e_orth (45°)=1−sin(y). (2)

For the purposes of determining e_orth(45° from the measured signals, it is necessary to mask other errors in the radius signal e_orth(x) or e. This may be carried out by a harmonic analysis by means of the Fourier transform. Here, the magnitude of the imaginary part of the 2^{nd} harmonic corresponds to the value e_orth (45° as a result of the Fourier transform. Here, the complete suppression of other errors in the signal e_orth(x) is advantageous by only considering the second harmonic, such as e.g., offset, gain or axial-offset errors, as these do not act on the second harmonic. Since the amplitudes are calculated as a result of the Fourier transform, but y describes the peak-to-peak value (from the minimum value to the maximum value), the magnitude of the imaginary part of the 2^{nd} harmonic needs to be doubled:

y=arcsin [2*(e_orth,2*n.,im)] (3)

The method according to the disclosure is advantageously developed such that the second or 2*n-th harmonic of the radius signal being ascertained by means of a Fourier transform, preferably a discrete Fourier transform. The discrete Fourier transform facilitates carrying out the aforementioned method with as little computational outlay as possible.

The method according to the disclosure is advantageously developed such that the imaginary component of the second or 2*n-th harmonic of the radius signal being used for calculating the correction value. This example is based on the idea of the error directly acting on the amplitude of the second harmonic, or an integer multiple of the second harmonic, of the radius signal and hence of an analysis of the amplitude of the second harmonic providing direct conclusions about the magnitude of the error. For example, this example is based on the discovery that the error in the second harmonic of the radius signal occurs with a phase shift of 90° in relation to the rotational angle, and so the imaginary component of the harmonic provides conclusions about the error.

The method according to the disclosure is advantageously developed such that the correction value being calculated on the basis of the equation:

y=Σ[arcsin(2*e_2*n,im)] (4)

or, preferably, on the basis of the equation

y=Σ[2*e_2*n,im] (5)

where e_2*n,im is the value of the imaginary component of the second or 2*n-th harmonic. In some examples, the latter simplification highlights an option, by means of which the computational outlay for determining the correction value may be reduced further. Here, this is based on the assumption that the correction value generally lies within a small value range around zero, and hence this assumption leads to a simplified calculation for a multiplicity of applications.

The method according to the disclosure is advantageously developed such that the value of the imaginary component of the harmonic being only ascertained at planned rotational angles (x_ST). This ensures that the imaginary component of the 2^{nd} or 2*n-th harmonic for an angle is not calculated a number of times within one rotation.

The method according to the disclosure is advantageously developed such that the values of the imaginary component of the harmonic being calculated at the rotational angles:

x_ST={0, 1, 1*2π/N, 2*2π/N, . . . , (N−1)*2π/N}, (6)

where N is a positive integer. This fixes the calculation of the imaginary component to fixed angles or angle positions. This is advantageous in that the calculation of the imaginary component may be established independently of the speed with which the rotational angle changes.

The method according to the disclosure is advantageously developed such that the correction value being set once for each sensor. The so-called offline calculation or ascertainment of the correction value requires little outlay based on the single calculation and may also be carried out by means of external computer units, as result of which production costs of sensor arrangements may be kept low.

Furthermore, another aspect of the disclosure provides an angle sensor arrangement that includes a sensor unit for capturing the raw rotational angle signals and an evaluation unit for carrying out a method according to one of the previously describes aspect of the disclosure and examples thereof.

Further, another aspect of the disclosure provides means of a drive device that includes an electric motor, in particular for a driver assistance apparatus, a control device for controlling the electric motor, and including an angle sensor arrangement according to the previously mentioned aspect of the disclosure.

The details of one or more implementations of the disclosure are set forth in the accompanying drawings and the description below. Other aspects, features, and advantages will be apparent from the description and drawings, and from the claims.

### DESCRIPTION OF DRAWINGS

The disclosure below is described in more detail according to examples and a plurality of figures. In the figures:

FIG. 1 illustrates a basic structure of an angle sensor for an angle sensor arrangement,

FIG. 2 illustrates an exemplary illustration of an orthogonality error in the angle sensor,

FIG. 3 illustrates a block diagram of an angle sensor arrangement for carrying out the method according to the disclosure,

FIG. 4 illustrates a detailed illustration of an determining unit from the block diagram in FIG. 3,

FIG. 5 illustrates a block diagram for carrying out a comparison test between an absolute setpoint angle value and the corrected rotational angle, and

FIGS. 6-8 illustrate a comparison of the results with and without rotational angle correction.

Some of the reference signs in the figures respectively have an index written as a subscript which, alternatively, is described by means of the sign “ ” in the subsequent description.

Like reference symbols in the various drawings indicate like elements.

### DETAILED DESCRIPTION

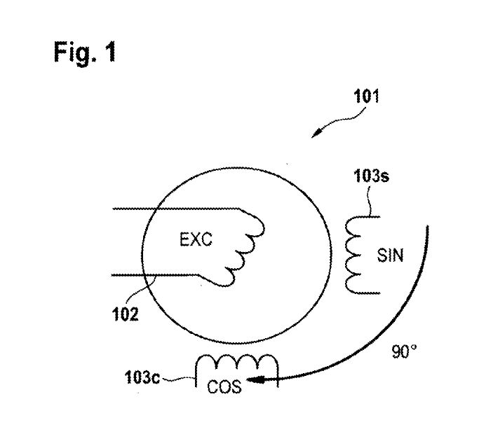

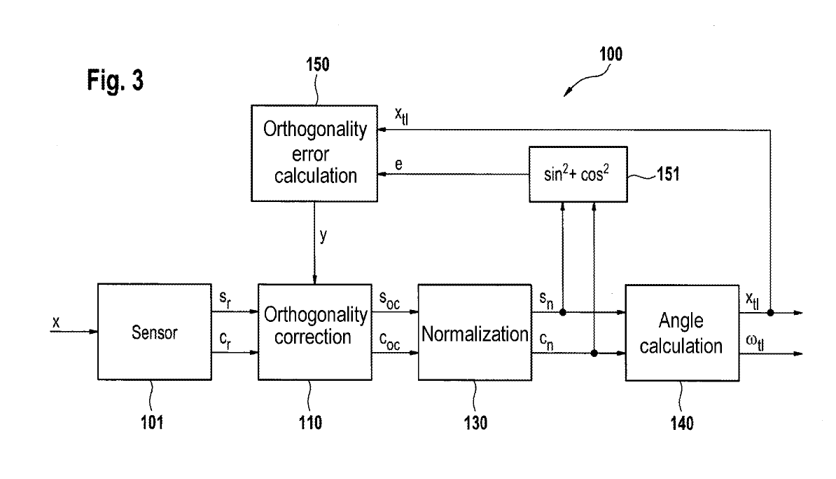

FIG. 1 shows the structure of an angle sensor 101 that is used in an angle sensor arrangement 100 shown in FIG. 3. Firstly, the angle sensor 101 includes an angle transducer 102. The angle transducer 102 predetermines a rotational angle signal x, which is captured by two sensor elements 103s, 103c. Each sensor element 103s, 103c generates a raw rotational angle signal s_r and c_r from the rotational angle signal x of the angle transducer 102. The raw rotational angle signal is used to calculate or determine the corrected rotational angle x_tl.

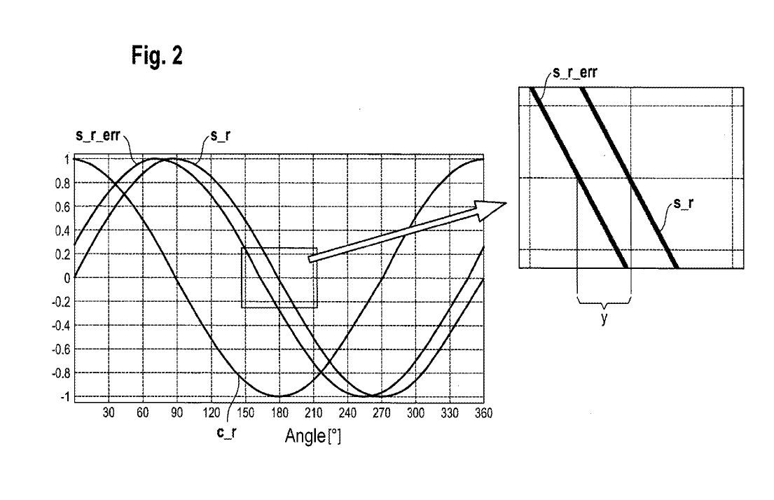

The raw rotational angle signals s_r, c_r are periodic signals in each case, for example a sine signal and a cosine signal, which have a 90° phase shift in relation to one another. Due to the orthogonal relationship between the sensor signals, the sensor signals may observe the condition according to the addition theorem sin²(x)+cos²(x)=1, where x is the value of the rotational angle. There may be a deviation from the orthogonal relationship between the two raw rotational angle signals s_r and c_r for a number of different reasons which, for example, may occur once during the production of the angle sensor 102 or due to external influences during operation, which are permanently present. An error case, in which the actual raw rotational angle signal s_r has an orthogonality error and therefore incorrectly assumes the profile of the curve s_r_err, is highlighted in an exemplary manner in FIG. 2. As a result, the phase shift between the two raw rotational angle signals is not 90° but 90°+y. The method facilitates determining this error as a correction value y.

FIG. 3 shows an angle sensor arrangement 100, which may be used to carry out the method according to the disclosure. Firstly, the angle sensor arrangement includes the angle sensor 101. The latter is connected to a correction unit 110. The correction unit 110 in turn is connected to a normalization unit 130. The normalization unit 130 is connected to an angle calculating unit 140. Furthermore, the angle sensor arrangement 100 includes a determining unit 150 for determining the correction value y. The determining unit 150 is connected to the correction unit 120 and provides the correction value y to the latter. In some examples, connected means a connection for transferring signals or data. Preferably, this is a data connection. In the figures, the connections are depicted by means of an arrow in each case. It is not mandatory for the angle sensor arrangement to include a normalization unit 140. However, this is advantageous.

The method is carried out in such a way that, firstly, the determining unit 150 determines a correction value y and provides the value to the correction unit 120. The correction value y is applied to at least one of the raw rotational angle signals s_r, c_r by means of the correction unit 120 for determining at least one corrected rotational angle signal s_oc, c_oc, from which the corrected rotational angle x_tl is calculated based on at least one of the corrected rotational angle signals s_oc, c_oc. In this example, it is the case that rotational angle signals s_oc, c_oc corrected by means of the correction value (y) are established for both raw rotational angle signals s_r, c_r and the corrected rotational angle x_tl is calculated by means of both corrected rotational angle signals s_oc, c_oc. Furthermore, this example may also include the step of normalizing the corrected rotational angle signals s_oc, c_oc to form normalized rotational angle signals s_n, c_n. For example, the normalization is carried out in such a way that the normalized rotational angle signals s_c, c_n then lie within a value range between −1 and 1.

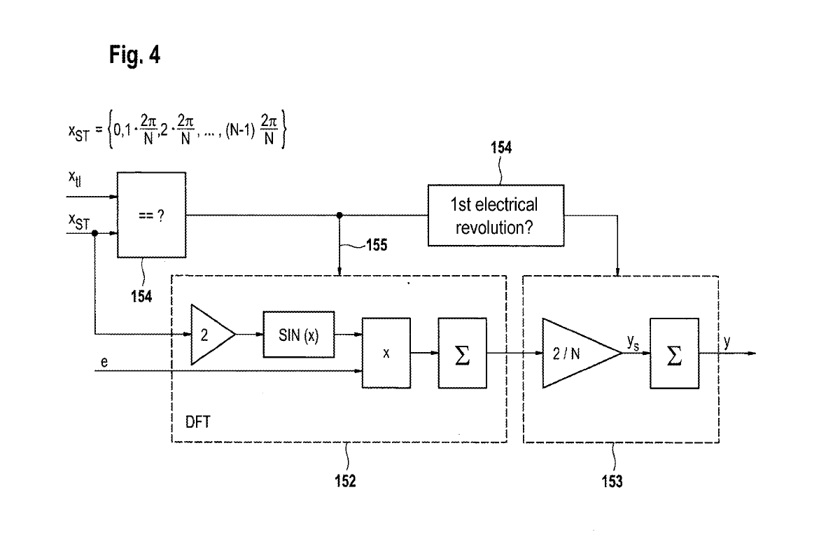

Moreover, the example has the property that the corrected and normalized raw rotational angle signals s_n, c_n are continuously retrieved for determining the correction value. To this end—as may be seen in FIG. 3 —the normalized rotational angle signals s_n, c_n are forwarded to a computer unit 151, in which a radius signal e is calculated by means of the expression s_n²+c_n². Then, the correction value y is calculated or determined in the determining unit 150 based on the radius signal. FIG. 4 shows the structure of the determining unit 150 in more detail.

The determining unit 150 firstly includes a DFT block 152 and secondly an integration block 153.

Within the DFT block 152, the 2^{nd} harmonic is calculated from the radius signal e by means of a discrete Fourier transform. Since only the imaginary component is decisive for determining the orthogonality error or the correction value y, it is possible to further simplify the calculation. That is to say, instead of carrying out the calculation by way of the equation:

$${\hat{e}}_{2} = {\sum }_{j = 0}^{N - 1} {e}^{- 4 π i \frac{j}{N}} * {e}_{j} , \qquad ( 7 )$$

the calculation may be specified further by the equation:

$${\hat{e}}_{2 , im} = \frac{1}{N} {\sum }_{j = 0}^{N - 1} sin 4 π \frac{j}{N} * {e}_{j} . \qquad ( 8 )$$

This is only carried out for specific angle positions or angles, however. To this end, the current corrected rotational angle x_tl is retrieved and a check 154 is carried out as to whether the current corrected rotational angle x_tl corresponds to a predetermined rotational angle x_ST stored in a memory. In a first run through, the corrected rotational angle x_tl may also be present in an uncorrected form. Preferably, the values of the predetermined rotational angle lie at nodes x_ST, which may be set as follows:

x_ST={0, 1, 1*2π/N, 2*2π/N, . . . , (N−1)*2π/N} (9)

Should this be the case, the calculation of the summand ê_2,im is carried out, elucidated by the arrow 155. Calculation of the sine signal may also be replaced by the use of a table with sine values that fit to the position x_ST.

An individual correction value y_s shown in the below equation:

y_s=arcsin(2*ê_2,im) (10)

may then be calculated from the imaginary component of the second harmonic ê_2 using the equation. Due to the assumption that the values of the imaginary component of the second harmonic lie closely around zero, it is also possible to carry out a simplification, namely shown in the below equation:

y_s=2*ê_2,im. (11)

In order to compensate the orthogonality error, the value y must be formed from the sum;

y=y+y_s (12)

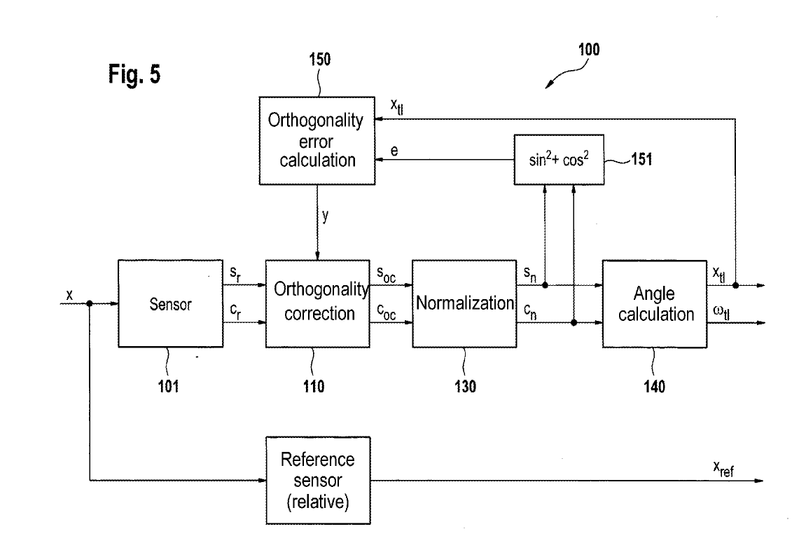

since an orthogonality error of y_s =0 would emerge when feeding back the determined compensation value y. The initial value of y is 0. In order to avoid sudden discontinuities in the angle signal x_tl, the signal y may have a change restriction, which may, for example, easily be realized by restricting the value of y_s. The effectiveness of the method according to the disclosure will be illustrated below in FIGS. 5 to 8.

FIG. 5 shows a structure that was used to carry out a simulation of the method according to the disclosure. The structure substantially corresponds to the structure of the angle sensor arrangement 100. In order to compare the effectiveness of the angle sensor arrangement 100 or of the method according to the disclosure, the value of a reference sensor x_ref was used to be able to make a comparison between the value of the reference sensor x_ref and of the corrected rotational angle x_tl.

The raw rotational angles x were undertaken on real resolvers with a subsequent simulation of the angle error, i.e., the angle error was artificially added. The signals x_ref, x_tl, s_r and c_r were recorded. Different orthogonality errors were used, as described below.

During the simulation, the signals s_r and c_r were introduced into the model as stimuli. Hence, two systems for calculating angles are realized, the systems receiving exactly the same input data. Firstly, there is the model simulation with automatic orthogonality compensation by means of the correction value y. Moreover, a controller without orthogonality compensation was also used for comparison purposes.

The angle x_tl calculated by the model may be compared to the reference angle x_ref and forms the angle difference x_diff,comp. Additionally, the angle error is calculated without orthogonality compensation from the measured values of the control device as x_diff for comparison purposes.

Both systems are provided with a time of approximately 3.2 seconds for settling before the simulation carries out the automatic orthogonality correction. As a result, the effect can be illustrated well visually.

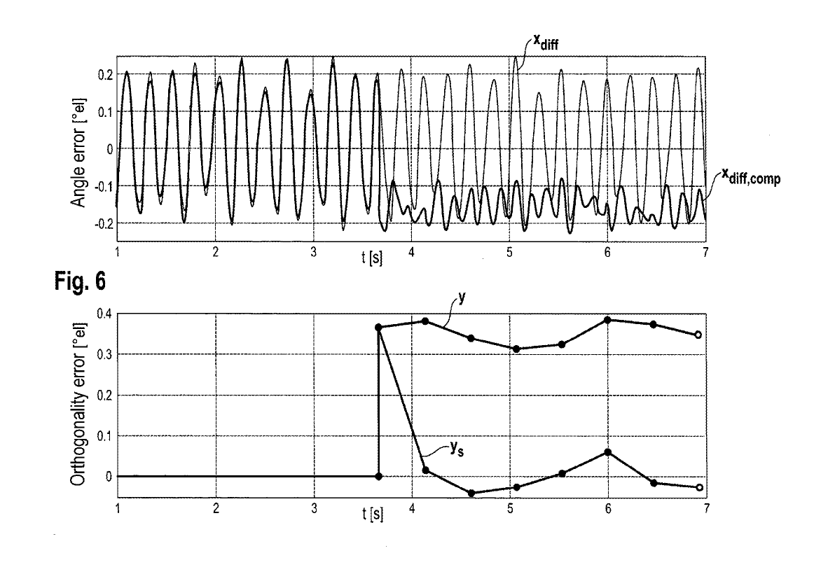

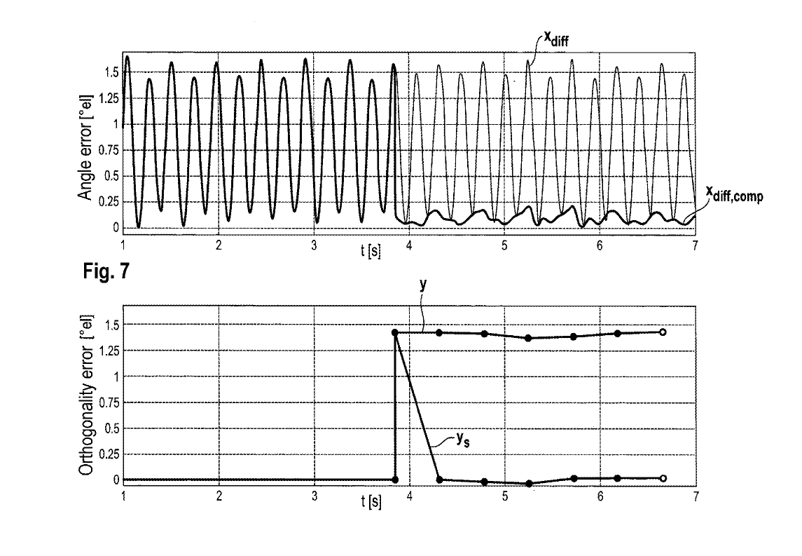

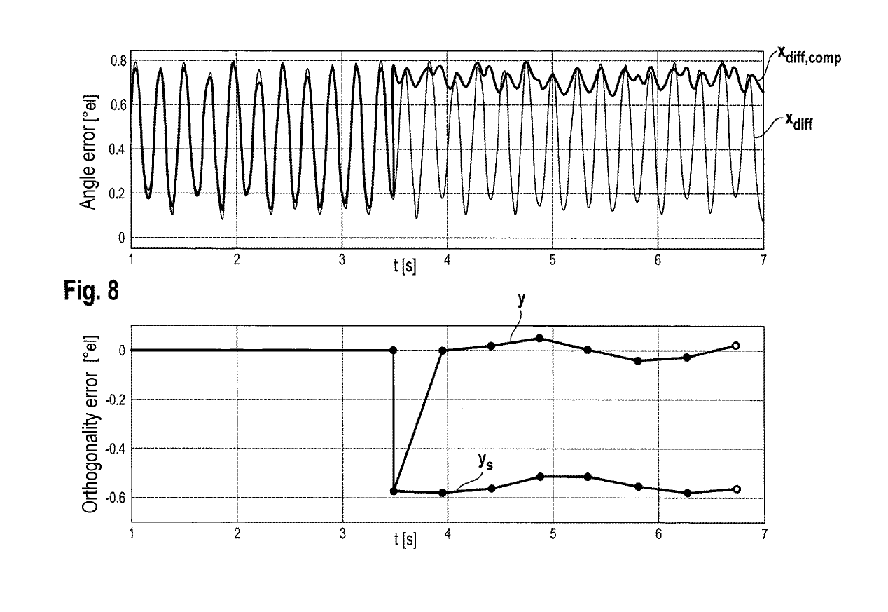

FIGS. 6, 7, and 8 show the results for resolvers with the following fed orthogonality errors: FIG. 6: 0.154° el, FIG. 7: 0.655° el, and FIG. 8: −0.3° el.

In the upper diagram, the angle error without compensation x_diff is depicted in each case as a red/dashed line. The compensated value x_diff_comp is as a blue/full line. The first value for the orthogonality error was determined at the time t=3.75 s and fed to the orthogonality compensation. The effect can clearly be seen; the angle error no longer has a dominant 2^{nd} order.

In the lower diagram, the signal y as the ascertained orthogonality error is depicted as a green/full line and the signal y_s as the ascertained residual orthogonality error is depicted as a blue/dashed line.

The clear reduction in the orthogonality error may be identified in FIGS. 6 to 8. In the application shown here, the residual angle error no longer has a critical magnitude.

The compensation value y was applied directly without smoothing, as a result of which angle discontinuities occurred, particularly in FIG. 7, when changing y. In return, it is easily possible to identify how y_s assumes the value of y once, in order subsequently to remain at the level of the identification accuracy. If y is smoothed, the signals y and y_s exhibit transient behavior.

It should be noted that the compensation value is the peak-to-peak value of the harmonic angle error. It therefore has the 2-fold value of y_s=arcsin(e_2,i,m). Furthermore, it may easily be identified that the correction of the orthogonality error removes the angle displacement in the order of the orthogonality error.

In some implementations, which may be combined with the aforementioned example are listed below.

In some examples, a method for determining an error (y) between two sensor signals (s1, s2) in an angle sensor, which depending on an angle transducer, outputs the sensor signals (s1, s2). The sensor signals have a periodic profile and are orthogonal to one another from a mathematical point of view. A deviation from the orthogonal relationship between the sensor signals may occur due to the error (y). The method includes the following steps: forming a radius signal (e_orth) by means of the sum of squares of the sensor signals; determining the 2*n-th harmonic of the radius signal (e_orth), where n equals a positive integer; and determining the error of a value of the amplitude, phase shifted by 90° in relation to the rotational angle value, at the second harmonic. In some examples, the method further includes determining a frequency component or frequency components of the radius signal by means of a Fourier transform and determining the error on the basis of the imaginary component of the frequency component or of the frequency components of the second harmonic. The Fourier transform may be carried out by means of a Fast Fourier Transform and/or discrete Fourier transform. In some examples, the error y may be calculated by means of equation:

y=arcsin|e_orth,2*n.,im| (13)

is established, where e_orth,2.,im maps the imaginary component of the amplitude of the 2*n-th harmonic of the radius signal.

In some implementations, the real component of the 2*n-th harmonic is used as a scale for a scaling error. The method may be used during running operation.

In some examples, the method is carried out prior to starting up an angle sensor, in particular by means of an external computer unit.

In some implementations, a method for determining an error (y) between two sensor signals (s1, s2) in an angle sensor which, depending on an angle transducer, outputs the sensor signals (s1, s2). The sensor signals have a periodic profile and are orthogonal to one another from a mathematical point of view. A deviation from the orthogonal relationship between the sensor signals may occur due to the error (y). The method includes the following steps: determining a rotational angle (x) from the sensor signals (s1, s2); determining a conversion value by carrying out a Fourier transform for the ascertained rotational angle; and determining the error based on the conversion value.

In some implementations, an angle sensor for capturing a rotational angle, includes a sensor element which outputs the sensor signals dependent on an angle transducer. The sensor signals have a periodic profile and are orthogonal to one another from a mathematical point of view, and a computer unit for carrying out the method as claimed in one of the preceding claims.

A number of implementations have been described. Nevertheless, it will be understood that various modifications may be made without departing from the spirit and scope of the disclosure. Accordingly, other implementations are within the scope of the following claims.

What is claimed is:

1. A method for determining a corrected rotational angle of a raw rotational angle captured by means of an angle sensor, said angle sensor outputting first and second raw rotational angle signals depending on the raw rotational angle, said raw rotational angle signals having a periodic profile and being orthogonal to one another, wherein a deviation from the orthogonal relationship between the sensor signals may occur on account of the error, said method comprising the following steps:
determining a correction value by means of an determining unit for determining the correction value and providing the correction value to a correction unit;
applying the correction value to at least one of the raw rotational angle signals by means of the correction unit for determining at least one corrected rotational angle signal; and
calculating the corrected rotational angle on the basis of at least one of the corrected rotational angle signals.

2. The method of claim 1, wherein the rotational angle signals corrected by means of the correction value (y) are ascertained for both raw rotational angle signals and the corrected rotational angle is calculated by means of both corrected rotational angle signals.

3. The method of claim 1, wherein the corrected rotational angle signals are normalized to form normalized rotational angle signals having a value range between −1 and 1.

4. The method of claim 3, wherein the corrected raw rotational angle signals, preferably the normalized raw rotational angle signals, are retrieved continuously for determining the correction value.

5. The method of claim 3, wherein the corrected rotational angle signals or the normalized rotational angle signals are retrieved depending on the corrected rotational angle for determining the correction value.

6. The method of claim 1, wherein determining the correction value comprises the following steps:
forming a radius signal by means of the sum of squares of the corrected or normalized raw rotational angle signals;
determining the 2*n-th harmonic of the radius signal, where n equals a positive integer; and
determining the error on the basis of a value of the amplitude, phase shifted by 90° in relation to the rotational angle, at the second harmonic.

7. The method of claim 5, wherein the second or 2*n-th harmonic of the radius signal is ascertained by means of a Fourier transform.

8. The method of claim 6, wherein the imaginary component of the second or 2*n-th harmonic of the radius signal is used for calculating the correction value.

9. The method of claim 5, wherein the correction value is calculated using equation:
y=Σ2*arcsin(e_2*n,im)
or, using equation:
y=Σ2*e_2*n,im,
where e_2*n,im is the value of the imaginary component of the second or 2*n-th harmonic.

10. The method of claim 6, wherein the value of the imaginary component of the harmonic is only determined at planned rotational angles.

11. The method of claim 9, wherein the values of the imaginary component of the harmonic is calculated at the rotational angles
x_ST={0, 1, 1*2π/N, 2*2π/N, . . . , (N−1)*2π/N},
where N is a positive integer.

12. The method of claim 1, wherein the correction value is set once for each sensor.

13. An angle sensor arrangement comprising a sensor unit for capturing the raw rotational angle signals and an evaluation unit for carrying configured to execute a method for determining a corrected rotational angle of a raw rotational angle captured by means of an angle sensor, said angle sensor outputting first and second raw rotational angle signals depending on the raw rotational angle, said raw rotational angle signals having a periodic profile and being orthogonal to one another, wherein a deviation from the orthogonal relationship between the sensor signals may occur on account of the error, said method comprising the following steps:
determining a correction value by means of an determining unit for determining the correction value and providing the correction value to a correction unit;
applying the correction value to at least one of the raw rotational angle signals by means of the correction unit for determining at least one corrected rotational angle signal; and
calculating the corrected rotational angle on the basis of at least one of the corrected rotational angle signals.

14. A drive device comprising an electric motor, in particular for a driver assistance apparatus, a control device for controlling the electric motor, and comprising an angle sensor arrangement including a sensor unit for capturing the raw rotational angle signals and an evaluation unit for carrying configures to execute a method for determining a corrected rotational angle of a raw rotational angle captured by means of an angle sensor, said angle sensor outputting first and second raw rotational angle signals depending on the raw rotational angle, said raw rotational angle signals having a periodic profile and being orthogonal to one another, wherein a deviation from the orthogonal relationship between the sensor signals may occur on account of the error, said method comprising the following steps:
determining a correction value by means of an determining unit for determining the correction value and providing the correction value to a correction unit;
applying the correction value to at least one of the raw rotational angle signals by means of the correction unit for determining at least one corrected rotational angle signal; and
calculating the corrected rotational angle on the basis of at least one of the corrected rotational angle signals.
